(19) United States
(12) Patent Application Publication
(10) Pub. No.: US 2023/0397596 A1
(43) Pub. Date: Dec. 14, 2023

(54) SEMI-AUTONOMOUS & TOWED IMPLEMENT ROBOTS FOR CROPPING APPLICATIONS

(71) Applicant: Tensorfield Agriculture, Inc., Union City, CA (US)

(72) Inventors: Zhe Xiong Chang, Palo Alto, CA (US); Sandeep Mirchandani, Palo Alto, CA (US); Louise Erin Thomas, Palo Alto, CA (US); Cheehan Francis Weereratne, Berkeley, CA (US)

(21) Appl. No.: 18/331,864

(22) Filed: Jun. 8, 2023

Related U.S. Application Data
(60) Provisional application No. 63/366,044, filed on Jun. 8, 2022.

(51) Int. Cl. A01M 21/04; F28D 15/00; B05B 12/12; B05B 12/08; B05B 1/08; A01M 7/00; G06V 20/10; G06T 7/70; G06V 10/77; G06V 10/75

(52) U.S. Cl. CPC A01M 21/04; F28D 15/00; B05B 12/12; B05B 12/084; B05B 1/08; A01M 7/0042; G06V 20/188; G06T 7/70; G06V 10/77; G06V 10/75; G06T 2207/30188

(57) ABSTRACT

Robots are used to dispense a substance, such as heated oil, on target vegetation, such as weeds or specialty crops. The robot can be semi-autonomous or a towed implement and includes an imaging module that captures images of a crop row with the target vegetation and a sprayer that dispenses a micro-dose or micro-doses of the substance. The robot also includes a control system that can determine the position of the robot and identify the target vegetation and its location. Based on this information, the control system activates a sprayer that dispenses the micro-dose of the substance onto the target vegetation in the identified location.

### CROSS-REFERENCE TO RELATED APPLICATIONS

This application claims priority and benefit from co-pending U.S. Provisional Patent Application 63/366,044, filed Jun. 8, 2022, and titled, “SEMI-AUTONOMOUS ROBOTS FOR CROPPING APPLICATIONS,” which is incorporated herein by reference in their entirety for all purposes.

### BACKGROUND

Many crops, especially specialty crops, require labor-intensive hand weeding to produce high crop yields, maintain adequate field, and plant health. Traditionally, this weeding is performed by hand with a crew of people visually identifying and physically pulling weeds from crop fields. The required weeding becomes even more labor-intensive and time consuming for organic specialty crops that have limited herbicide use when compared with conventional methods, which is the ability to use approved, non-organic pesticides and fertilizers.

Weed control for conventionally grown vegetable crops requires a multi-pronged strategy, primarily consisting of mechanical tillage/cultivation, pre- and post-emergent herbicide applications, and hand weeding. Both mechanical cultivation and the application of herbicides serve to reduce the weed pressures that need to be addressed with subsequent hand weeding. The hand weeding component of weed control often requires a substantial labor force that is skilled in weed identification.

Mechanical cultivation, where the top surface of the soil is disturbed to uproot weeds, has the effect of breaking up the soil crust, which reduces water retention capabilities, can negatively impact soil health, and can cause collateral damage to crops, as well as bringing up more weed seeds from lower layers of the soil which serves to further increase weed pressures later in the growing cycle. Mechanical cultivation also requires adequate spacing around the crops in order to pull instruments through the soil without uprooting desired crops, rendering it unsuitable for intra-row spaces of densely grown vegetables such as onions, carrots, and salad greens.

The use of approved herbicides is highly restricted in organic operations, and, for conventional operations, is restricted by the potential for damage to desired crops. Post-emergence, herbicides can be used successfully when the weeds are controlled by a mode-of-action to which the desired crop is resistant. When a range of weed species are present, however, it becomes increasingly unlikely that the desired crop is resistant to every mode of action that is required to treat the range of weeds. Any herbicide application also has the risk of damaging adjacent crops and fields through overspray, and of creating an environment of selective pressures that increase the likelihood of weeds developing herbicide resistance.

Some autonomous or semi-autonomous solutions have been developed including targeted herbicide delivery that help address some of the issues associated with herbicide application. However, commercially available targeted herbicide delivery devices do not provide an adequate level of precision for post-emergent weeding in densely grown crops, which risks harming the crop, damaging soil quality, and ineffectively spending resources on expensive herbicides without the intended result. Other autonomous or semi-autonomous solutions rely on potentially harmful lasers to eradicate the weeds, which presents a physical danger to surrounding humans and a high level of cost and complexity. Lasers also have the disadvantage of being applicable to only the smallest of weeds, due to the small area over which the laser energy can be directed at any given time. Each of these automated or semi-automated solutions presents substantial drawbacks in safety risks, efficacy, precision, and resource investment, which prevents the agriculture industry from adopting them as complete weeding solutions. Instead, hand weeding remains a necessary and labor-intensive input, especially for specialty crops and organics, which keeps costs high and requires complicated resource management.

Farmers, investors, grocers, futures traders, agriculture finance experts, and the like would benefit from improved ways of weeding crops in a safe, precise, and cost-efficient manner. These stakeholders would also benefit from systems of crop management like crop development monitoring with forecasting tools. These advanced tools would produce greater efficiencies throughout operations of the crop business, which results in expanding availability of healthy, herbicide free crops across the globe. This would take a step forward to close an inequity in available food sources and feed larger populations with less harm.

The specialty crop market in particular struggles with controlling weed growth during crop cultivation. Hand weeding is a vitally important input, which is a time, cost, and human resource intensive investment to produce quality crops with an acceptable yield. The agriculture industry has been slow to adopt alternatives, such as targeted herbicide delivery or technology solutions like weed eradication with lasers. These alternatives have efficacy challenges and are often unsafe for humans, plants, and soil. Further, crops grow resistant to herbicide use over time, which increases the reliance on hand weeding. Crop monitoring is nearly impossible, especially at the individual plant or crop row level because of the vast physical distance crop fields cover.

Farmers and other stakeholders would benefit from improved weed eradication systems that require less reliance on human crews and from crop monitoring systems that can track data at the plant or crop row level.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 shows an example robot according to aspect of the disclosure.

FIG. 2 shows an example ON/OFF transition of a sprayer on an example semi-autonomous robot in accordance with aspects of this disclosure.

FIG. 3 illustrates a field of view of two adjacent cameras and two adjacent sprayer manifolds each with respective nozzles.

FIGS. 4A and 4B show two example configurations of sprayer nozzles.

FIG. 4C shows a heated spray manifold module according to aspect of the disclosure.

FIG. 4D shows a portion of a robot design with integrated pneumatic accumulators.

FIG. 4E shows an example sprayer with three rows of nozzles.

FIG. 5 shows an example robot navigation a turn at an end of a crop row.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

The disclosed robotics and correlate algorithms support crop identification, plant imaging, real-time or near real-time weed/organic material identification, and controls for dispensing targeted heated oil or fertilizer. The imaging relies on vision software to input ingested data to the algorithm. The ingested image data is analyzed through various image processing techniques and can be used as input to a control system that dispenses the precise micro-dose of the heated oil from the array of jets onto the weeds (or conversely the fertilizers onto the plants). The ingested data can also be analyzed by a metrics or tracking module that helps to generate reports in real-time or post-event and prepares validated data forecasting on crops along with being the basis for alerts to concerning conditions or events with the plants. While the ends users are farmers and those specifically in the agriculture business, other stakeholders in agriculture such as traders, investors, financiers, purchasers, grocers, public health organizations, governments, and food processing companies can also benefit from this crop phenotyping.

The disclosed systems and methods are important in cropping agribusiness to cultivate crops without the use of harmful herbicides in an efficient and effective manner with minimal manual labor requirements—this allows farmers to grow more crops with fewer inputs, allowing organic farmers to avoid herbicides altogether, conventional farmers to reduce their use of herbicides, increase crop yields, and reduce labor costs associated with hand weeding. These benefits drive down the overall cost of farming and improve the healthy foods available to people all over the globe. The same innovation can be expanded within all cropping applications, from specialty to row crop production for conventional as well as organic operations.

The same targeted application of heated vegetable oil can be used to revolutionize the process of organic thinning, which is often performed with expensive manual labor. Thinning is the process of removing unwanted crops after germination, where farmers deliberately sow excess seed in anticipation of germination rates being under 100%. In the thinning process, the unwanted crops are identified by the robotics systems in a similar way to the identification of weeds. The robotics systems then apply heated oil to the identified unwanted crops, which allows for the desired crops to continue growth after germination (or any other phase of growth) without unwanted crops drawing resources.

This same targeted application of fluids in crop fields can be expanded to apply fertilizers, bio-stimulants, or any other fluid-based treatments to the crop. The disclosed robots and algorithms would identify the weeds and spray non-weed organic material detected in an ambient environment or would identify the non-weed organic material as the primary target. In either scenario, fertilizer or any other fluid-based treatment can be applied using the same precision array of sprayers.

Still further, the same disclosed systems and methods can be used to analyze plants to perform vision-based phenotyping (tracking plant growth process and behavior), yield prediction (how mature and how healthy is the plant), and disease detection and prevention for plants. These analytics can be offered in the form of reports, trending metrics, crop forecasts, etc. to help farmers and stakeholders in the crop supply chain plan for all crop outcomes with greater predictability and precision.

In an example, the disclosed semi-autonomous robot is a self-propelled agricultural sprayer weighing ˜1,000 kg in some examples, which applies targeted lethal doses of heated edible vegetable oil to post-emergence weeds on vegetable beds while leaving crops to flourish unharmed. A semi-autonomous robot determines its position and controls its navigation. This example robot travels at ˜2 kph and treats one 80-inch bed at a time—the standard bed size for specialty crops such as carrots and leafy greens. Size, weight, and/or velocity of this example robot and the treatable bed size could be different in alternative examples.

Alternatively, the robot could be a towed implement, as needed. A towed implement is a robot that is towed behind another vehicle and is not in control of its navigation. The towed implement may, however, determine its position with respect to the crops to be able to precisely dispense the substance, such as the heated vegetable oil.

Weeds and crops are distinguished in real time using data captured with image sensors, such as low-latency global shutter RGB sensors at 60 FPS, where this data is fed to an artificial intelligence (AI) algorithm, such as an object detection inference algorithm or a semantic segmentation algorithm or any combination of algorithms to aid in categorizing and localizing each individual plant present on the vegetable beds. The AI algorithms could be run on onboard processing units such as one or more rack-mounted GPU servers, or on smaller embedded processing units such as multiple Jetson Xaviers®, or one or more Jetson Orins® to run any selected algorithm(s) to detect objects in the captured image(s). An array of individually controlled spray nozzles arranged in two rows perpendicular to the direction of travel affords 12.5 mm spatial resolution to selectively kill weeds in the most challenging of specialty crops such as carrots. Alternatively, an array of three rows of individually controlled spray nozzles provides 7.5 mm spatial resolution to selectively kill weeds. The spatial resolution perpendicular to the direction of travel is dependent on the nozzle configuration and spacing. The spatial resolution in the direction of travel is dependent on many things including (but not limited to) travel speed, spray pulse cycle time, chamber volume (or dead volume) between the solenoid valve and nozzle exit, and many other aspects of the nozzle design.

An object or objects can be detected across a series of captured images either taken simultaneously or over a time-lapse period. In an example, the object could be detected by identifying a common characteristic in each of the images that correlate to the target object.

Some example robots have a self-leveling payload that adjusts for any uneven medium, such as roll of the robot caused by uneven ground in a crop row. The self-leveling payload helps to adjust the nozzle positions to maintain them at a consistent height above the crop bed.

A post-spray checking system using thermal imaging cameras overlays the actual sprayed area against the expected sprayed area, providing a real-time feedback loop to correct for systemic bias in the sprayer targeting system.

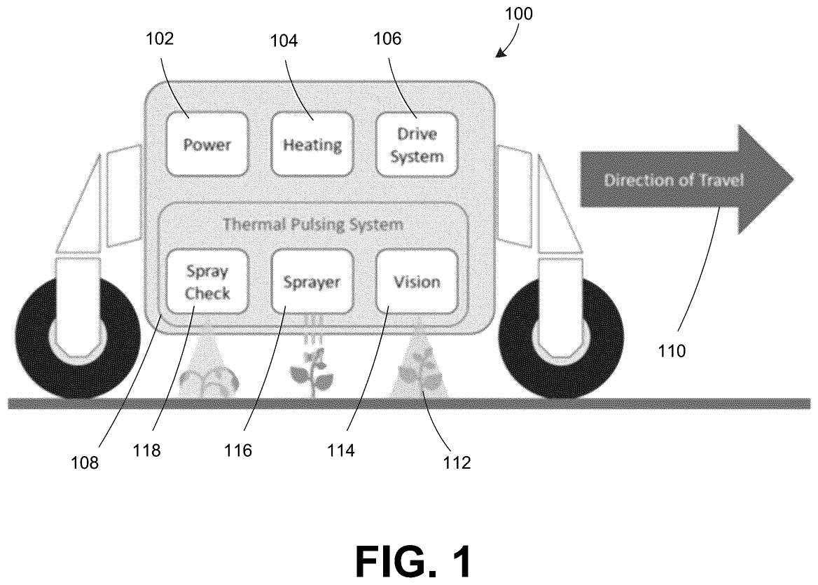

Turning now to FIG. 1, an example robot and control system 100 includes a power source 102, heating system 104, drive system 106, and a thermal pulsing system 108. This robot and control system 100 can be semi-autonomous or could be a towed implement, depending on the application and desired design. As the robot 100 moves in a direction of travel 110 along a row of crops 112, its thermal pulsing system identifies weeds using a sophisticated optical vision system 114, then sprays those weeds with a sprayer 116 using micro-doses of heated oil in a precise manner. The oil is typically heated to approximately 160° C., which produces a burn-hazard zone of only a few meters to humans in the event of mechanical failure, and none during standard oil deposition and little if any soil disruption. Proper operation of the robot prevents human injury. Alternative technology uses lasers powered at about 150 W that have a much larger human danger zone in the event of an unintended encounter with a reflective surface on the field. Lasers are also restricted to a highly idealized narrow band of allowable weed growth stages in order to be effective. This is impractical for safe human operation and effective weed control, which is why the heated oil sprayer is a better option over lasers.

A spray checker 118 of the thermal pulsing system confirms that the weeds were sprayed and can optionally validate whether they exhibit beginning eradication features.

The robot and control system 100 shown in FIG. 1 can determine the position of the robot by one or more of visual odometry (e.g., by processing captured images), wheel odometry, and/or accelerometer values. The visual odometry data can be captured by any image sensor, such as one or more image sensor(s) like a camera. The wheel odometry data is measured by one or more position sensors that determine the position of one or more of the robot wheels. The accelerometer values are measured by one or more accelerometers positioned in various locations on the robot. In some examples, the image(s) used to determine the visual sensor data to help determine the robot position can be the same or a different image module than the optical vision system 114 that determines the proper dispensing of the micro-doses of the heated oil. In an example, the same image or set of images can be used to both determine the robot position and to determine the micro-dose of the heated oil to dispense. That image or set of images can be captured by one or multiple image sensors.

In an example, the robot control system continuously captures images and determines the robot's relative position based on those images and data from the wheel odometry sensors and accelerometer readings. The continuously captured images can also be used to help the robot navigate between rows or avoid objects (and other navigation maneuvers) using a control algorithm. The same continuously captured images can also be used to identify the plants as vegetation or weeds using a detection algorithm. In the continuously captured images, some of the images can be used for navigation or control of the robot while others can be used for detection or analysis of plants. Further, some of the images may be used for both robot control and plant analysis.

The droplet formation of the heated canola oil as it leaves its individual nozzle is important to allow the quick ON/OFF transition of the nozzle. The ON pulse must be quick—its duration is about 10 milliseconds. The controller relies on a GPIO input signal being high or low to determine the ON/OFF instruction, and the duration of the nozzle opening for each pulse is determined by the length of the input signal, which is programmed and calibrated for each solenoid valve to account for part-to-part variation in the solenoid valves themselves.

The disclosed robot, such as the robot shown in FIG. 1, uses a solenoid driver that detects both the opening and closing of the valve, which improves the accuracy of the detected time when the valve is open and dispensing heated oil. It detects the current of the open condition and closing condition to identify a signature of the time the valve is open. This signature analysis provides the information required to calibrate the solenoid driver output to each specific valve, to ensure precise quantities of fluid can be emitted from each valve despite part-to-part variations.

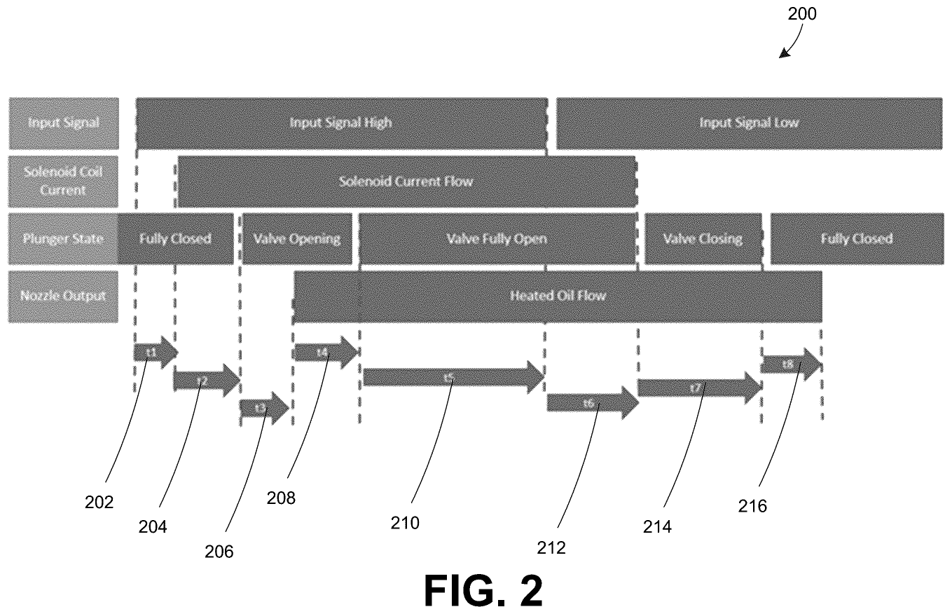

The droplet formation of the heated canola oil as it leaves its individual nozzle is important to allow the quick ON/OFF transition of the nozzle. The ON/OFF transition of the nozzle 200 is represented in FIG. 2. A custom solenoid driver has been built which independently controls the opening and closing of each individual nozzle, and which detects part-to-part manufacturing variations in a calibration routine to ensure a precise dose of fluid is emitted from every nozzle.

For a target travel speed of 0.5 meters per second (approximately 2 kph, or one acre per hour for a standard 80-inch bed) and a spatial resolution in the direction of travel of 1 cm, the duration of heated oil flow from the nozzle during one pulse must be less than 20 milliseconds, and the pulsing system must be able to fully cycle at a rate of 50 Hz in order to prevent over-spray. The solenoid valve used is a direct acting, normally closed solenoid valve.

In FIG. 2, the period t1 202 represents the delay between input signal to the solenoid driver going high and current flow being initiated in the solenoid coil. This is fast—on the order of microseconds.

The period t2 204 represents the delay between solenoid current beginning to flow and the valve beginning to open due to the buildup of the solenoid's magnetic field. The duration of the period t2 204 can be minimized by building the solenoid current faster, which is achieved by overdriving the solenoid with a 48V spike voltage which is 8× greater than the rated design voltage of the solenoid. Pulse width modulation is employed to reduce the effective voltage across the solenoid coil once the valve is open to avoid overcurrent and burnout. With custom solenoid drivers, t2 204 has been measured as <0.5 milliseconds.

The combined period t2 204+t3 206+t4 208 is the delay between the solenoid current beginning to flow and the solenoid valve plunger completing its stroke to the “fully open” position. With custom drivers this has been observed to be circa 3.5 milliseconds. This combined period is affected by spike voltage applied to the coil, inductance of the solenoid coil, mass of the ferrous plunger, stiffness of the solenoid valve return spring and viscosity of the fluid medium.

The period t5 210 is the time between when the valve is fully open and when the valve close is initiated with Input Signal set to low. Adjusting this period in software adjusts the volume of liquid that is dispensed by the pulsed dosing system. Longer periods can be used to dose larger volumes of heated oil for weeds which require more thermal energy transferred to them in order to be successfully treated.

The period t6 212 is the time taken between Input Signal set to low and the time at which the current flowing through the solenoid coil is stopped. This period t6 212 is minimized by applying a large negative voltage across the solenoid coil. This is achieved by implementing a voltage clamp—using a Zener diode to provide a flyback path for the inductor current back to the supply voltage rail. In testing, period t6 212 is circa 3 milliseconds.

Period t7 214 is the time taken to close the valve from the moment the inductor coil current is stopped. The duration of this period is driven by return spring stiffness, plunger mass and fluid viscosity. Period t7 214 has been observed to range from 5 to 30 milliseconds, depending on the spring stiffness and the maximum displacement of the plunger during the opening phase.

The period t8 216 is the time during which fluid continues to exit the nozzle after the valve is fully closed. This can also be viewed as the time required for the pressure drop across the nozzle to fall to zero after the valve is closed. This period is a function of nozzle design parameters such as cross-sectional area of dosing channels, number of dosing channels, chamber volume between the outlet and the valve seat, fluid viscosity and fluid compressibility.

The controller relies on sensed current flowing through the solenoid coil in order to determine the state of the solenoid valve. The controller can sense the current flowing within the solenoid coil and uses the characteristic shape of the current flow plotted against time (collected during a calibration routine) to determine the valve-specific spike duration during opening which is required to achieve uniform opening characteristics across all solenoid valves. This is important in order to prevent coil burnout by limiting the current in the coil to below a predetermined level, and a signature analysis of the sensed current is performed during a calibration routine for each valve/nozzle combination to ensure that dosing is consistent between each nozzle.

In some examples, the disclosed robot includes a gas-powered generator together with a LiFePO4 battery as the power source for computation, motor actuation and heating of the thermal fluid via an electrical process heater that in turn heats the dispensed oil via heat exchangers. Alternatively, the power source for heating of the thermal fluid may be derived from a propane (or other fuel) fired burner or set of burners onboard the robot.

The thermal pulsing system includes optical sensors in the form of cameras with lighting along with vision processing, which ingest the images captured by the cameras into the image processing algorithms that identify the weeds. The thermal pulsing system also includes a heated sprayer array that dispenses heated oil according to a control algorithm. The control algorithm determines the heated oil dispensing based on the image processing, known data (distance between plants, typical dosing required to eradicate particular weed varieties, etc.). The thermal pulsing system also includes thermal check cameras that confirm the weeds were sprayed by again imaging the weeds and finding characteristics of the post-spray weed images that indicate the weed has been sprayed and/or is beginning the eradication process.

The drive system of the disclosed robot, which includes 4 independent drive and steer suspension modules to allow the robot to smoothly maneuver along a crop row and turn at the end of the row to begin its work on the next crop row. The robot also includes an oil container in which the oil is stored. The control system causes the designated amount of oil to be dispensed from the storage container to be heated in the heated sprayer array, then dispensed in targeted micro-doses onto the weeds.

More specifically, the thermal pulsing system includes a drive controller that controls and adjusts the physical movement of the example disclosed robot as it moves along and navigates between rows of crops. The control algorithm creates a weed map or target map for dispensing the heated oil based on the location, type, height, width, and distance from the nozzles of the processed images of the weeds. A detection camera and a depth camera capture images of the weeds, their features, and the surrounding soil, and then feeds it to the control algorithm that then identifies the weeds and creates the weed map for targeted heated oil micro-dosing. The depth camera is used to determine the distance between the targets on the spray map and the nozzles of the thermal pulsing system. Subsequent images from the detection camera have significant overlap, which enables multiple images to be stitched together to create a continuous 3D spray map, complete with depth information from the depth camera so that variations in bed height and plant height are taken into account and fed into the targeting pipeline. The position, velocity and orientation of the thermal pulsing system are determined in real-time using a combination of visual odometry, wheel encoder readings and inertial measurement units placed at each corner of the example disclosed robot.

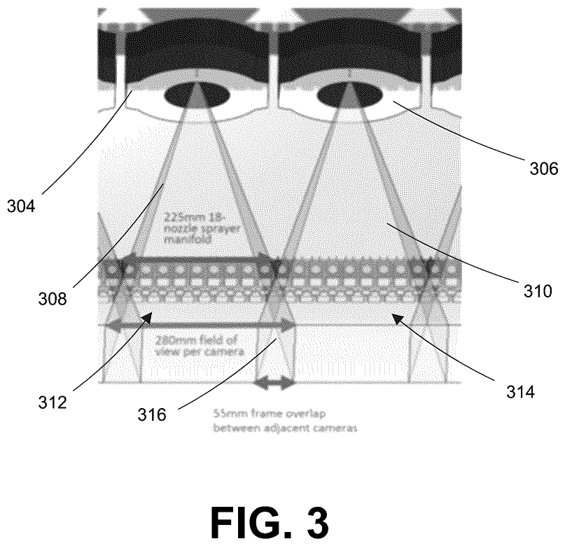

FIG. 3 shows two camera and lighting systems 304, 306 each with a 280 mm field of view 308, 310 at the crop bed and two corresponding nozzle sprayer manifolds (each with 18 individually controlled nozzles, 312, 314) which are 225 mm wide and spaced 225 mm apart. One camera and lighting system 304 corresponds to the output of one sprayer manifold 312. Adjacent camera and lighting systems and their respective sprayer manifolds are placed side by side at 225 mm intervals to provide coverage for the entire crop bed regardless of plant spacing and seed-line configuration.

The thermal camera of the thermal pulsing system validates that the weeds have been sprayed according to the weed map using a thermal camera, such as a FLIR Boson that detects the temperature of the heated oil on the surface of the weeds, as detected in the images it captures. The heated map overlaid on its images confirms that heated oil was properly deposited on the weeds and optionally confirms that it was or was not deposited on surrounding soil or organic material.

The vision and targeting system of the thermal pulsing system includes multiple RGB vision units with 1080×1440 resolution, 280×210 mm field of view (FOV), 60 FPS, global shutter, and RGB. A ring light surrounds the camera or vision units to enhance frame capture. Alternatively, a strobed LED bar light could be used to enhance frame capture. Each camera has a 280 mm FOV. Each camera's FOV overlaps with the FOVs of its respective lateral adjacent camera(s). In the example shown in FIG. 3, there is a 55 mm overlap area 316 between the adjacent camera FOVs 308, 310.

In an example, the semi-autonomous robot employs a depth camera, such as the Intel Realsense® D435i, to acquire depth data of the crop bed. The obtained data is then fed to the weed mapping algorithm to determine the distances between the spray targets and the sprayers. Moreover, the depth camera integrates with the visual odometry stack, allowing the coupling of RGB detection camera images with distance information. This coupling is crucial in accurately assessing the true size of objects within the images. Notably, objects closer to the camera will appear larger compared to those positioned further away. By leveraging the depth camera, precise measurements of object distances from the cameras can be obtained, enabling the deduction of object size and position for precise targeting. The weed detection pipeline consists of image capture, object detection and weed map updating. It takes approximately 75 milliseconds for the Image Capture process to deliver an image taken in real time to the detection algorithm. The detection algorithm takes approximately 15 milliseconds to identify targets in the image. The output of the detection algorithm together with the depth camera information is used to update the weed map in real time. The updated weed map is fed into the targeting pipeline. This process is repeated at 60 fps, meaning the weed map is updated every 15 milliseconds with information that was collected in real time 90 milliseconds ago.

The image capture pipeline consists of a Sony IMX296 RGB color image sensor with a MIPI CSI-2 data interface to transfer the image to the embedded vision system GPU for raw image processing and color correction. Edmund Optics Rugged Blue Series imaging lens are chosen as they have been ruggedized to prevent pixel shift and maintain optical pointing stability even after exposure to shock and vibration.

The targeting pipeline uses the data from the RGB camera, depth camera, and positioning components of the example disclosed robot (wheel odometry, IMU, vision), to update the weed map at 60 FPS. The continuously updated weed map, the position model, and the velocity model are all fed into the targeting system that then controls solenoid valves that dispense micro-doses of heated oil onto the weed in a targeted manner.

The solenoids of the sprayers are activated by the targeting system. The sprayer unit is a heated nozzle manifold. For example, the sprayer units can each be dedicated to a camera. Each manifold can have 18 sprayers with 18 respective solenoids valves controlling the sprayers. In the example system shown below, the example disclosed robot includes 8 cameras. The 8 cameras cover a full 80-inch crop bed, which can be adjusted in alternative embodiments to account for different crop bed sizes, as needed.

The example disclosed robot has multiple sensors positioned to detect tilt and spin of the example disclosed robot in motion. The angle at which the oil is dispensed from the nozzle(s) is important to precisely target the weeds according to the weed map.

Inertial measurement units (IMUs) located at each corner of the robot are used to detect the tilt and spin of the example disclosed robot in motion. The angle at which the oil is dispensed from the nozzle(s) is important to precisely target the weeds according to the weed map. For example, if due to uneven terrain the example disclosed robot payload is determined to have rotated with positive pitch (front raised higher than rear), then the targeting pipeline will compensate for the resulting offset in spray landing position. Roll, pitch, and yaw dynamics are all accounted for using the onboard IMUs.

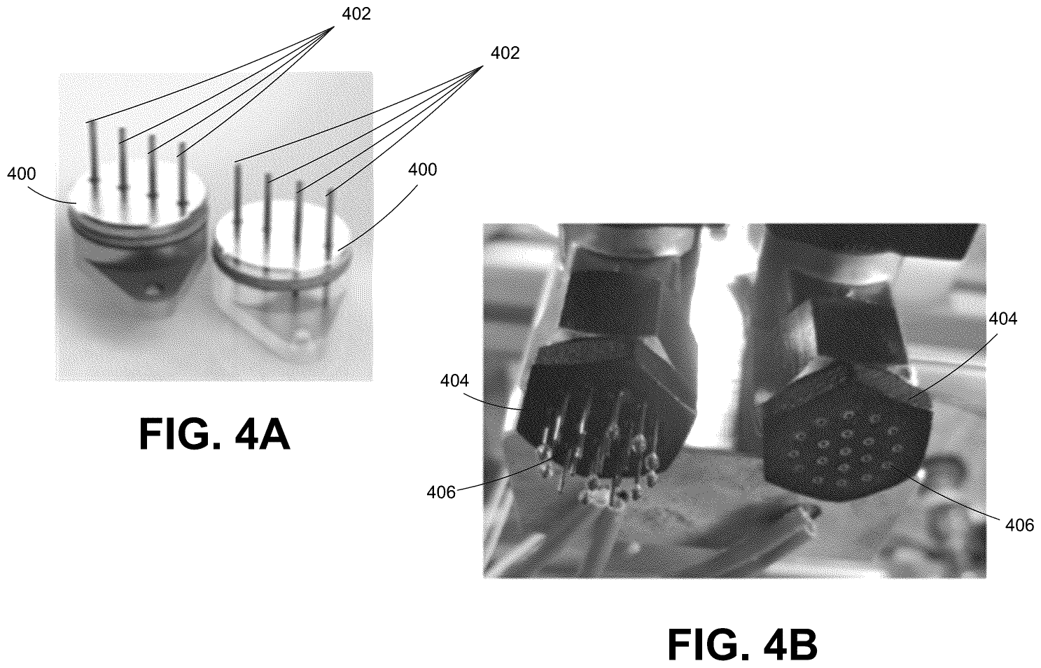

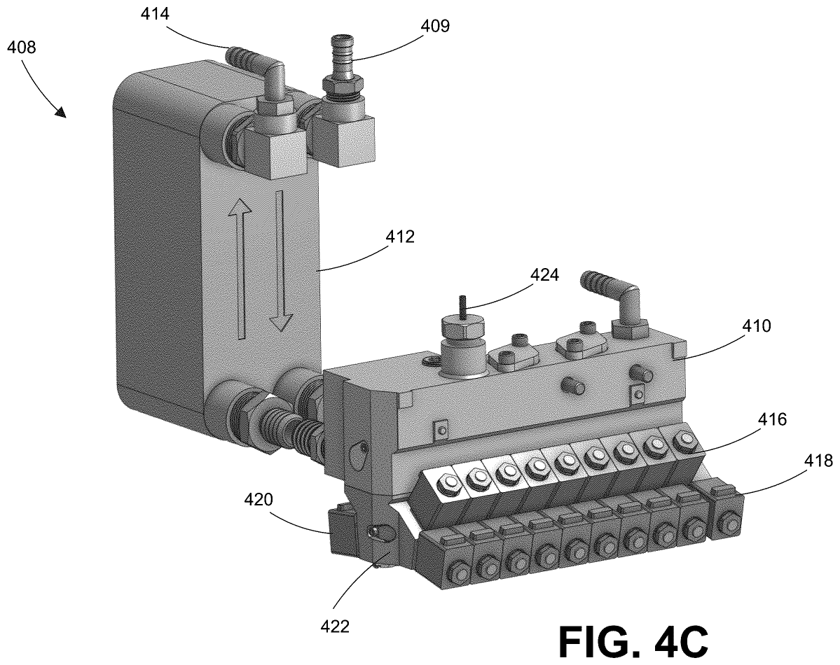

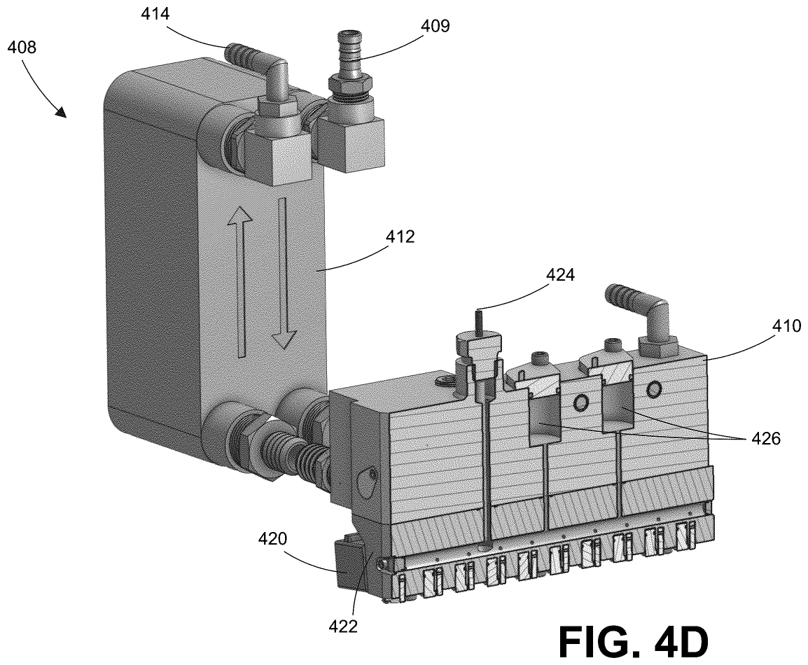

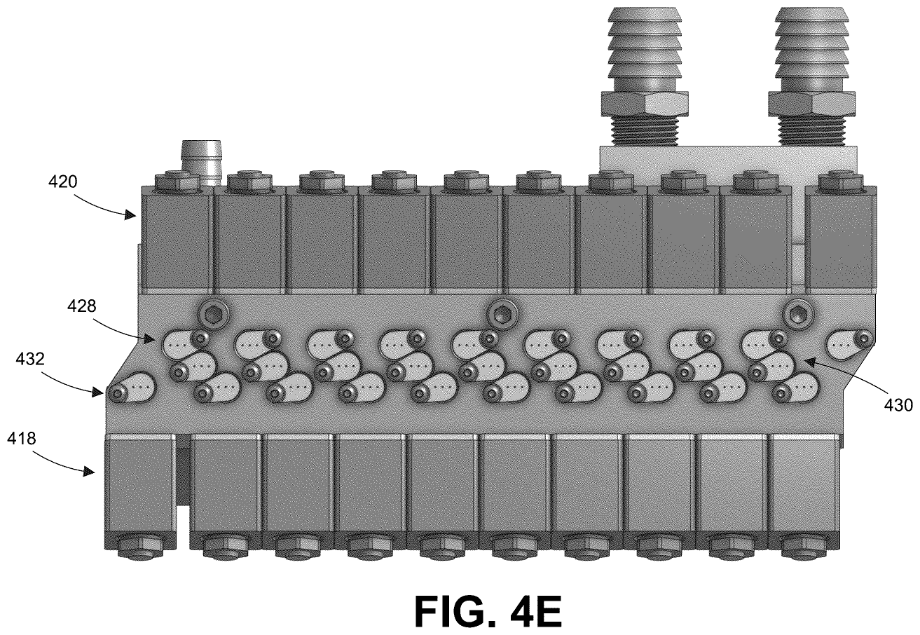

The sprayer unit nozzle design can be configured to best suit the crop. They can be interchangeable, if needed, or a universal nozzle, if preferred. Example nozzle configurations are shown in FIGS. 4A and 4B. FIG. 4A shows two nozzles 400 each having 4 needles 402 that dispense oil. The diameter of the needles can vary depending on the size of the droplet that is dispensed. The size of the droplet can be correlated to the type of target crop or weed, which can vary depending on the size, spacing between plants or weeds, etc.

The example shown in FIG. 4B has two nozzles 404 in a hexagon shape with 18 machined channels 406, each being 0.2-0.3 mm of inner diameter with a length/width ratio of at least 45. Shorter channels than this length/diameter ratio produced dripping rather than targeted deposition of heated oil. Alternative shapes can be employed, as needed, such as the four-channel, circular design shown above.

Some example nozzles include needles attached or glued to openings through which the heated oil is dispensed. Other example nozzles include machined holes with channels through which the heated oil is dispensed. A non-stick coating, such as an electroless nickel plating with PTFE can be added to the machined nozzle to prevent polymerization or build-up of the dispensed oil.

FIGS. 4C-4D shows an example of a heated spray manifold design with two distinct fluid pathways which ensure rapid and consistent heating of the crop applicant (“substance”) at the point of deposition onto the target vegetation.

The substance pathway has an inlet 409 where the substance at ambient temperature flows into the heat exchanger 412 where it is heated to circa 160 C before it enters the upper spray manifold 410. The substance only flows from the upper spray manifold 410 into the lower spray manifold 422 when one or more of the solenoid valves controlled by the three banks of solenoid coils 416, 418, 420 is switched ON and substance is being deposited onto targets. The substance remains heated within the lower spray manifold 422 and consistently pressurized by pneumatic accumulators 426 machined into the upper manifold, ready for deposition onto targets via the three rows of individually solenoid-valve-controlled nozzles installed at the base of the lower spray manifold 422. The temperature of the substance within the spray manifold 410, 422 is continuously monitored using a temperature probe 424.

The thermal fluid pathway is separate and distinct from the substance pathway and is configured to maintain the entire sprayer manifold assembly 408 at a target temperature and to rapidly heat the substance on demand via the heat exchanger 412. The heated thermal fluid enters the upper manifold 410 and flows through the upper manifold 410 along its length to maintain the temperature of the substance contained within the lower manifold via thermal conduction. This functions as an integrated heat exchanger between the substance and the thermal fluid within the manifold. The thermal fluid flows continuously and recirculates, entering the bottom of heat exchanger 412 after exiting the upper manifold which heats the incoming substance. After flowing up through the heat exchanger 412, the thermal fluid exits the heat exchanger at an outlet 414 before returning to the process heater of the robot to be reheated and recirculated.

The robot can also include two pneumatic accumulator chambers 426 machined into the upper manifold 410. Alternatively, any suitable number of pneumatic accumulator chambers 426 can be included. The pneumatic accumulator chambers maintain the proper spray pressure to emit the heated oil through banks of solenoid coils 416, 418, and 420 that control the ON/OFF of each nozzle. The pneumatic accumulators 426 can be part of an oil pressure regulating system that maintains the pressure of the heated oil that is dispensed from the sprayer.

FIG. 4E shows two banks of solenoid valves 418, 420 with three rows of teardrop-shaped nozzles 428, 430, 432 each with 3 holes in them. These nozzles 428, 430, 432 are controlled by the solenoid valves 416, 418, and 420.

Solenoid control is important to achieve high spatial resolution when operating the example disclosed robot at speed so the heated oil is deposited at the intended location—on the targeted weeds. The solenoid valves are able to be rapidly cycled. Rapid cycling of the solenoid valves produces a spray deposition pattern with distinct treatment patches that show that oil spray is contained within the area intended for treatment only, minimizing potential overspray damage.

Thermal micro-dosing of the weeds is important to effectively eradicate each weed with a high reliability. Using the cameras discussed above to identify the weeds, the control algorithm uses a deep learning technique to detect the weeds. It can identify images of weeds within 10 to 15 milliseconds. The algorithm ingests the images of the weeds and compares characteristics of the image(s) or a portion of them to determine the weed type. One example is to compare a color or shape of a suspected weed or a portion of it to either a gold standard or empirical data about that weed type. Once a weed is detected, the sprayer or sprayers nearest the weed are instructed to turn on for a specific length of time to cover a specific physical region—i.e., 20 ms for 1 cm. The sprayers nearest the weed are pulsed for a short length of time—for example 0.75 milliseconds. This 0.75 millisecond pulse length results in output flow for say 12 milliseconds, which will result in a patch length (treated area) of say 12 mm. The tilt and spin data discussed above regarding the tilt and movement of the example disclosed robot is factored into the determination of which sprayers to activate, the length of time, and the physical region to spray.

For example, if the example disclosed robot is travelling at constant speed over a target, with zero tilt or spin detected by the IMUs, then the release of oil from the nozzles can be timed using a simple kinematics model where the oil falls vertically under constant acceleration due to gravity and with a horizontal component of velocity which matches travel speed of the robot in order to dose within an expected spray region. However, if the example disclosed robot is moving on a tilt or grade—which is most often the case—then tilt and speed of the example disclosed robot adjusts the direction, time duration, and location of the heated oil deposition accordingly. The trajectory of the jet stream is adjusted based on the tilt and speed data of the example disclosed robot.

Other ambient environment sensors can also be included to detect environmental conditions or factors that would affect the trajectory of the oil jet stream, such as a network of ultrasonic sensors that ping each other to detect wind speed and direction to adjust for the impact of ambient conditions on the flight path of the fluid jet. This would improve targeting accuracy.

Further, the droplets of dispensed heated oil must be dispensed at a precise temperature below a specific Reynold's Number to maintain the heated oil deposition as a laminar flow jet stream of heated oil instead of forming atomized spray at the nozzle end.

After heated oil is deposited through the spray unit(s) according to the weed map, the spray check system validates whether the targets were reached, whether surrounding spray or drip occurred, and the like (results of the heated oil deposition) using a thermal camera and the vision camera. The thermal camera detects a region of heat that is within a targeted temperature range of 50 to 100 degrees C. The spray check controller determines an oil to weed overlap based on the heat image from the thermal camera and the weed image from the vision camera for multiple images. It then determines a score of matching the oil to weed overlap from the captured images to determine a level of successful deposition of heated oil on the weeds.

To heat the oil—in this example, canola oil—the example disclosed robot uses a heat-on-demand, first-in-first-out system. Because of the dose-on-demand nature of targeted application, fluid pressure is provided independently of flow rate by use of a hydro-pneumatic accumulator. The canola oil is heated via a heat exchanger at the point of delivery, through which a second food-safe recirculating thermal fluid is pumped using a conventional oil heater and pump combination.

The heated canola oil is not continuously recirculated because that constant heat oxidizes the canola oil, blocking the nozzles over time compared to the heat-on-demand option. In the heat-on-demand option, the hydro-pneumatic cylinder/bladder-style accumulator acts as a stable pressure source for the canola oil deposition with pressure pneumatically controlled by an air pump. The heat exchanger is positioned near the nozzle to heat the canola oil just prior to its deposition. The thermal fluid is recirculating food-grade heating oil that is heated by a recirculating electric mold heater.

For effective heated oil delivery, the pressure needs to be stable at the heated oil source. Oil pressure is conventionally maintained by constant recirculating flow through a restriction. Because the example disclosed robot is drop-on-demand, where the spray needs to be stopped for periods of time, it uses a pneumatic accumulator in combination with a fluid pump and control valves to maintain steady pressure independent of fluid flow rate.

In the example disclosed robot design, the nozzles themselves are heated, either as a group of nozzles—by nozzle “units” or groups within a nozzle unit or groups of nozzle units—or individually. A food-safe recirculating thermal fluid is heated by an industrial oil heating unit, and this fluid is continuously recirculated through the manifold block which houses the solenoid valves and nozzles which deposit the heated canola oil. By continuously recirculating the thermal fluid at a temperature of 175 C, a stable temperature in excess of 160 C is maintained at the nozzles, ensuring that the canola oil is always heated to a lethal temperature for weeds at the point of deposition, and no cooling down of the heated oil takes place while waiting to be dispensed.

The heating of the canola oil can be thought to occur in two stages: the first stage is as it passes through a multi-plate heat exchanger, through which the 175 C heated thermal fluid is constantly recirculated. The resulting 175 C skin temperature of the canola oil within the heat exchanger is below its smoke point of circa 200 C. This is important to prevent degradation of the oil and fouling of the heating system. The second stage of heating of the canola oil occurs in the manifold block itself, where the same 175 C thermal fluid is constantly recirculated in order to maintain the high temperature of the entire deposition system.

The pressure in the oil storage container needs to be monitored using an oil pressure system to maintain pressure between 100-110 kPa.

The example disclosed robot is controlled by robotic platform that has independent steering for each wheel that includes a slewing ring and slip ring mechanisms to allow for precision turning among closely spaced rows of crops. It also has passive spring-damper suspension struts and a VESC open-source BLDC motor controller.

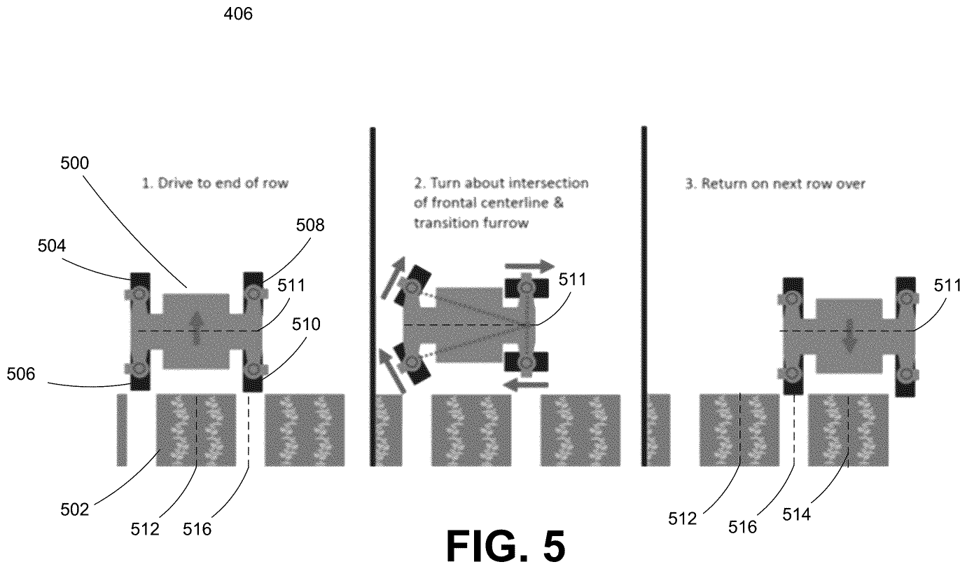

Turning now to FIG. 5, the robot size relative to the space between the crop rows 502 makes it difficult to accurately execute maneuvers at the end of a crop row 502. The independent steering for each wheel 504, 506, 508, 510 gives maximum control over the positioning and turning radius of the example disclosed robot. The robot 500 turns about the intersection of the robot's frontal centerline 511 and the transition furrow 516. As shown in FIG. 5, each wheel 504, 506, 508, 510 can independently move to rotate the robot 500 around an end of the crop row 502. Upon completion of the turn, the robot 500 is able to return down the next crop row aligning itself along that crop row's centerline 514.

The example disclosed robot is powered by a gasoline-powered generator, which produces electricity for the industrial heater which is used to heat the recirculating food-safe thermal fluid which in turn heats the canola oil from ambient temperature to weed-lethal temperature (>160 C). The gasoline-powered generator also produces electricity which trickle-charges a LiFePO4 battery on board. This battery powers all other electronics on board example disclosed robot, including the motors for locomotion, the lighting systems for image acquisition, onboard cameras, and vision processing units.

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

What is claimed is:

1. A robot, comprising:
an imaging module having an image sensor configured to capture an image of a crop row with target vegetation;
a manifold having:
an integrated manifold heat exchanger configured to continuously recirculate a heated thermal fluid to heat the manifold, and
an integrated sprayer configured to dispense a targeted micro-dose of a substance; a sprayer configured to dispense a targeted micro-dose of a substance;
a control system including one or more processors configured to:
determine a position on the pathway of the robot;
initiate the imaging module to begin the capture of the image of the crop row;
identify target vegetation in the captured image and a location of the target vegetation in the crop row;
activate the sprayer to dispense the targeted micro-dose of the substance on the target vegetation in the identified location.

2. The robot of claim 1, wherein the target vegetation is a weed.

3. The robot of claim 2, wherein the control system is further configured to create a weed map based on the identified target vegetation in the captured image and the location of the target vegetation in the crop row.

4. The robot of claim 1, wherein the target vegetation is a specialty crop.

5. The robot of claim 1, wherein the sprayer has an array of individually controlled spray nozzles.

6. The robot of claim 5, wherein the individually controlled spray nozzles are arranged in two rows or three rows perpendicular to a direction of travel of the robot along the pathway.

7. The robot of claim 6, wherein the integrated manifold heat exchanger is configured to heat the individually controlled spray of the sprayer.

8. The robot of claim 1, wherein the sprayer includes a pulsing system configured to dispense the substance in a series of pulsed micro-doses.

9. The robot of claim 1, wherein the substance is an oil heated by the manifold heat exchanger prior to dispensing to a temperature of 160° C.

10. The robot of claim 1, wherein the substance is a fertilizer.

11. The robot of claim 1, wherein the control system includes at least one on-board processor.

12. The robot of claim 1, wherein the control system includes multiple processors, one of which is an on-board processor, and further comprising a communications module electronically coupled to the remote processor and configured to transmit data between the on-board processor and a remoting computing system.

13. The robot of claim 1, wherein the robot includes a position sensor configured to determine the position of the robot on the pathway.

14. The robot of claim 1, wherein the control system is further configured to determine the position of the robot on the pathway by analyzing a characteristic of the captured image.

15. The robot of claim 1, wherein the control system is further configured to identify the target vegetation in the captured image by analyzing a characteristic of the captured image.

16. The robot of claim 15, wherein the control system is further configured to identify the target vegetation in the captured image by inputting the captured image to an artificial intelligence (AI) algorithm to detect the target vegetation in the captured image based on an image characteristic of the captured image.

17. The robot of claim 1, wherein the control system is further configured to identify the target vegetation in a series of captured images by analyzing a common characteristic of the series of captured images.

18. The robot of claim 1, wherein the control system further comprises a post-spray checking module configured to:
initiate the imaging module to begin capture of a post-spray image of the target vegetation,
determine an actual sprayed area of the target vegetation from a characteristic in the post-spray image,
compare the actual sprayed area to an expected sprayed area of the target vegetation, and
determine a difference value of the actual sprayed area to the expected sprayed area of the target vegetation, and
output the difference value.

19. The robot of claim 18, wherein the control system is further configured to adjust a subsequent spray of the target vegetation based on the difference value.

20. The robot of claim 1, wherein the control system is further configured to transmit an instruction to the sprayer to initiate an ON pulse of 10 milliseconds (ms) in which the sprayer is open to form a droplet to dispense as the targeted micro-dose of the substance when the robot is moving at a speed of 0.5 meters per second along the pathway over the crop row.

21. The robot of claim 1, wherein the robot is a semi-autonomous robot.

22. The robot of claim 1, wherein the robot is a towed implement.

23. The robot of claim 1, wherein the processor is further configured to determine the position on the pathway of the robot based on a position characteristic in the captured image.

24. The robot of claim 23, wherein the processor is further configured to determine the location of the robot based on the position characteristic in the captured image.

25. The robot of claim 24, wherein the processor is further configured to determine the location of the robot based on one or both of wheel odometry sensor data from a wheel position sensor on the robot and accelerometer data received from one or more accelerometers positioned on the robot.

26. The robot of claim 1, wherein the processor is further configured to determine the location of the target vegetation in the crop row based on the captured image.

27. The robot of claim 1, wherein a second, spray manifold heat exchanger is located adjacent to or near the integrated sprayer.

28. The robot of claim 1, wherein the recirculated thermal fluid is a food-safe fluid flowing through a closed-loop system and heated by an electric or gas-fired process heater.

29. The robot of claim 28, wherein the food-safe fluid is heated to a temperature of 175 C.

30. The robot of claim 29, wherein the substance is canola oil heated by the food-safe fluid to a temperature of 160 C prior to the canola oil being dispensed from the sprayer.

31. The robot of claim 1, wherein the substance is an oil, and further comprising an oil pressure monitoring system configured to monitor the pressure of the oil dispensed through the sprayer.

32. The robot of claim 31, wherein the oil pressure monitoring system includes one or more pneumatic accumulators integrated into the manifold and configured to maintain constant pressure of the oil dispensed through the sprayer.

33. The robot of claim 1, further comprising a temperature sensor configured to monitor a temperature of one or both of the heated thermal fluid and the substance.
